(19) United States
(12) Patent Application Publication
(10) Pub. No.: US 2009/0074329 A1
(43) Pub. Date: Mar. 19, 2009

(54) IMAGE DISPLAY APPARATUS AND METHOD THEREFOR

(75) Inventors: CHENG-HAO CHOU, Tu-Cheng (TW); XIAO-GUANG LI, Shenzhen City (CN); BO-CHING LIN, Tu-Cheng (TW); KUAN-HONG HSIEH, Tu-Cheng (TW); BING LI, Shenzhen City (CN); ZAI-AN PAN, Shenzhen City (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/174,633

(22) Filed: Jul. 17, 2008

(30) Foreign Application Priority Data
Sep. 14, 2007 (CN) 200710076995.X

(51) Int. Cl. G06K 9/60; G09G 3/36

(52) U.S. Cl. 382/305; 345/87

(57) ABSTRACT

The present invention provides an image display apparatus and an image display method adapted for the apparatus. The apparatus stores a plurality of image files and metadata of each of the image files. The metadata includes a selection count and a weighted value of the image file. The weighted value is calculated according to the selection count. The image display method includes steps of: receiving image selection signals; receiving an image display signal; reading the weighted values of selected image files to generate a list in an order according to the weighted values; updating the selection counts of the selected image files; calculating the weighted values of the selected image files according to the updated selection counts, and storing the updated selection counts and the calculated weighted values as metadata; and displaying the selected image files according to the list.

### TECHNICAL FIELD

The present invention relates to image display apparatuses, and more particularly, to an image display apparatus and an image display method according to a weighted value of an image file.

### GENERAL BACKGROUND

There are a variety of image display apparatuses in the market today, such as digital photo frames, personal computers, and the like. Digital photo frames are gradually replacing conventional picture frames. While a conventional picture frame with a transparent front panel and backing material can normally only frame a single paper picture, a digital photo frame with an integrated circuit (IC) built in is able to store a large number of digital image files, and display the digital image files in a predetermined manner on a display, such as a liquid crystal display (LCD). Digital photo frames can change digital image on the display automatically. On the other hand, changing paper pictures in conventional picture frames must be done manually.

When a user searches for and selects a favorite digital image file or files to display on an image display apparatus, the user must remember a directory path where digital image is stored. If there are many images stored in the image display apparatus, the user may not be able to remember all the directory paths and has to do a manual search, which can be even more time consuming than changing paper pictures in a conventional picture frame. These manual operations may be annoying and there is no guarantee that the search will yield the desired results.

Accordingly, what is needed in the art is an image display apparatus that overcomes the aforementioned deficiencies.

### SUMMARY

An image display apparatus is provided. The image display apparatus includes an input unit, a display unit, a storage unit, a control unit, and an image management unit. The input unit is for generating input signals in response to input. The input signals comprise an image selection signal and an image display signal. The display unit is for displaying image files. The storage unit is for storing a plurality of image files and metadata of each of the image files. The metadata for each image may include a selection count and a weighted value. The weighted value is calculated according to the selection count, and stored as metadata.

The control unit is for selecting image files when receiving image selection signals from the input unit, reading the weighted values of selected image files and generating a list in an order according to the weighted values when receiving an image display signal from the input unit, and controlling the display unit to display the selected image files according to the list. The image management unit is for updating the selection counts of the selected image files when the image files are displayed, calculating the weighted values of the image files in accordance with the updated selection counts, and storing the updated selection counts and the calculated weighted values as metadata.

Other advantages and novel features will be drawn from the following detailed description with reference to the attached drawings.

### BRIEF DESCRIPTION OF THE DRAWINGS

The components in the drawings are not necessarily drawn to scale, the emphasis instead being placed upon clearly illustrating the principles of the image display apparatus. Moreover, in the drawings, like reference numerals designate corresponding parts throughout the several views.

FIG. 1 is a block diagram of a hardware infrastructure of an image display apparatus in accordance with an exemplary embodiment of the present invention.

FIG. 2 is a flowchart illustrating a method of displaying image files on the image display apparatus of FIG. 1.

### DETAILED DESCRIPTION OF THE EMBODIMENTS

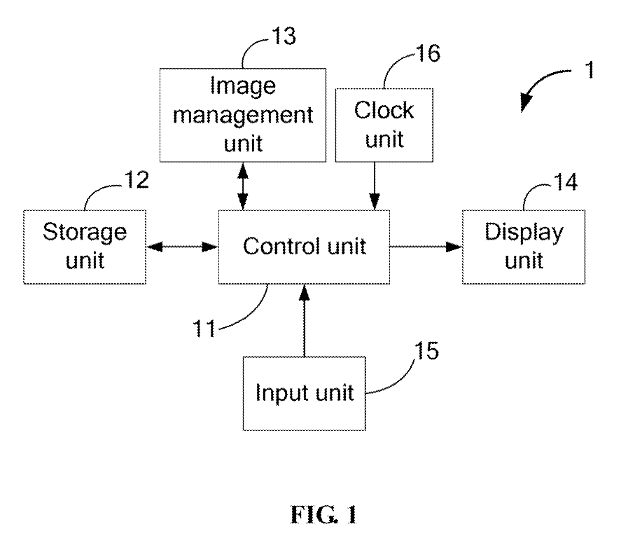

FIG. 1 is a block diagram of a hardware infrastructure of an image display apparatus in accordance with an exemplary embodiment of the present invention. The image display apparatus 1 (hereinafter “the apparatus”) includes a control unit 11, a storage unit 12, an image management unit 13, a display unit 14, an input unit 15, and a clock unit 16. The storage unit 12 is used to store a plurality of image files and metadata of each of the image files.

In the present embodiment, each of the image files includes a tag, which stores metadata of the image file. The tag includes several items of information, such as a selection count, a weighted value, an upload timestamp, and an image size. The selection count indicates a display count of the image file. The weighted value indicates a weighted value assigned to the image file. The weighted value is calculated according to the selection count, and using the following formula: W=F(N), such as, W=AN, wherein A is a constant. The upload timestamp indicates when the image file was loaded to the apparatus 1. The image size indicates a size of the image file.

In another exemplary embodiment of the present invention, an image information table is provided to store metadata of each of the image files. The image information table includes an image name column, an upload timestamp column, a selection count column, and a weighted value column. The image name column records titles of the image files, such as A, B, and the like. The upload timestamp column records the timestamp of when an image file was loaded to the apparatus 1, for example, the upload timestamp of an image file A to the apparatus 1 is T1. The selection count column records the display count of an image file, for example, the selection count of an image file B is N2. The weighted value column records a weighted value assigned to an image file, for example, the weighted value of an image file C is W3.

Image Information Table

| Image name | Upload timestamp | Selection count | Weighted value |
|---|---|---|---|
| A | T1 | N1 | W1 |
| B | T2 | N2 | W2 |
| C | T3 | N3 | W3 |
| D | T4 | N4 | W4 |
| . . . | . . . | . . . | . . . |

The weighted value indicates a preference associated with an image file. In addition, the weighted value can be also set and adjusted in accordance with a user's preferences. For example, the user can manually increase the weighted value of a favorite image and decrease the weighted value of a less favorite image.

The input unit 15 generates input signals to the control unit 11 in response to input. For example, when an input is image selection, the input unit 15 generates an image selection signal; when an input is display request, the input unit 15 generates an image display signal. The control unit 11 receives and identifies the input signals from the input unit 15, and controls the storage unit 12, the image management unit 13, the display unit 14, and the clock unit 16. For example, when receiving the image selection signal, the control unit 11 selects the corresponding image file or files. If a single image file is requested, it is displayed on the display unit 14. When receiving the image display signal, and more than one image file has been selected, the control unit 11 reads the weighted values of the selected image files and generates a list of the selected image files in an order, e.g., a descending order, according to the read weighted values. The control unit 11 controls the display unit 14 to display the selected image files according to the list. Consequently, the image files having greater weighted values would be listed first in the list.

The image management unit 13 updates the selection counts of the image files when the image files are displayed. It re-calculates the weighted values of the selected image files according to the updated selection counts, and stores the updated selection counts and the calculated weighted values as metadata. The clock unit 16 is configured for providing a current timestamp. The selection count can be a total selection count, an average selection count per week, an average selection count per month, and the like. The total selection count indicates a total display count since the image file was loaded to the apparatus 1. The image management unit 13 subtracts the upload timestamp from the current timestamp of the clock unit 16 to get upload weeks/months. The total selection count divided by the upload weeks/months is an average selection count per week/month. The average selection count per week/month indicates an average display count per week/month since the image file was loaded to the apparatus 1.

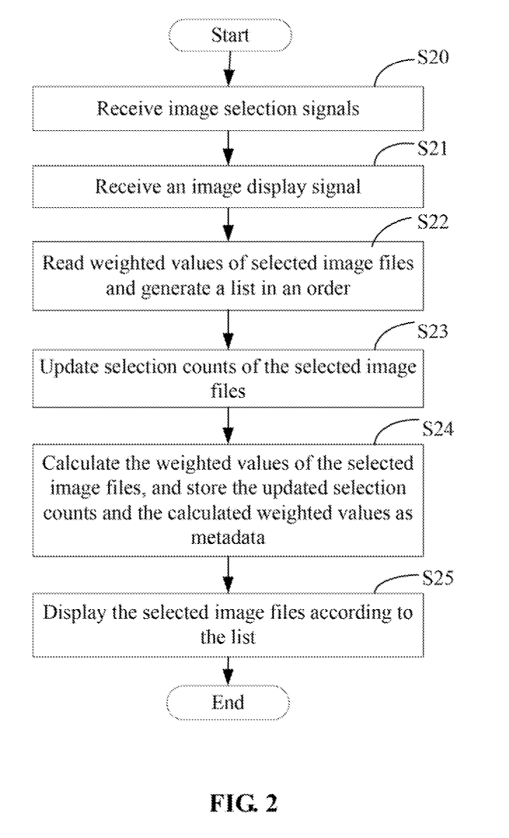

FIG. 2 is a flowchart illustrating a method of displaying image files on the image display apparatus of FIG. 1. In step S20, when a user inputs a request, the input unit 15 generates the image selection signals to the control unit 11 according to the input, and the control unit 11 receives the image selection signals and selects the corresponding image files. In step S21, the control unit 11 receives the image display signal from the input unit 15. In step S22, the control unit 11 reads the assigned weighted values for each of the selected image files and generates the list of the selected image files in the order determined by their weighted values. In step S23, the image management unit 13 updates the selection counts of the selected image files, namely where the image management unit 13 adds one to the selection count of each of the selected image files. In step S24, the image management unit 13 calculates the weighted values of the selected image files as detailed previously, and stores the updated selection counts and the calculated weighted values as metadata. In step S25, the control unit 11 controls the display unit 14 to display the selected image files according to the list.

After generating the list, the control unit 11 stores the list in the storage unit 12. Accordingly, when receiving a list display signal, the display unit 14 displays the image files in the list directly.

In addition, the weighted value can also be dependent on other operations, such as deletion requests, addition requests, and the like, initiated by a user. That is, when one of the image files is deleted or an image file is added to the list, the weighted value thereof is re-calculated therewith, and the list is re-arranged accordingly.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. An image display apparatus comprising:
an input unit, for generating input signals in response to input, wherein the input signals comprise an image selection signal and an image display signal;
a display unit, for displaying image files;
a storage unit, for storing image files and metadata of each of the image files, wherein the metadata of each image includes a selection count and a weighted value, and the weighted value is calculated according to the selection count;
a control unit, for selecting image files when receiving image selection signals from the input unit, reading the weighted values of selected image files and generating a list in an order according to the weighted values when receiving an image display signal from the input unit, and controlling the display unit to display the selected image files according to the list; and
an image management unit, for updating the selection counts of the selected image files when the image files are displayed, calculating the weighted values of the image files in accordance with the updated selection counts, and storing the updated selection counts and the calculated weighted values as metadata.

2. The image display apparatus as recited in claim 1, wherein each image file comprises a tag for storing the metadata.

3. The image display apparatus as recited in claim 1, wherein the storage unit further stores an image information table for storing the metadata.

4. The image display apparatus as recited in claim 1, wherein the control unit is further configured for storing the list in the storage unit after generating the list.

5. The image display apparatus as recited in claim 4, wherein when receiving a list display signal, the control unit is configured for reading the weighted value of each image file in the list to re-arrange the image files in the order accordingly.

6. A method of displaying image files on an image display apparatus, wherein the image display apparatus stores image files and metadata of each of the image files, the metadata comprises a selection count and a weighted value of each image file, and the weighted value is calculated according to the selection count, the method comprising:
receiving image selection signals;
receiving an image display signal;
reading the weighted values of selected image files and generating a list in an order according to the weighted values;
updating the selection counts of the selected image files;
calculating the weighted values of the selected image files according to the updated selection counts, and storing the updated selection counts and the calculated weighted values as metadata; and
displaying the selected image files according to the list.

7. The method of displaying image files as recited in claim 6, further comprising storing the list after generating the list.

8. The method of displaying image files as recited in claim 6, further comprising when receiving a list display signal, reading the weighted value of each image file in the list to re-arrange the image files in the order accordingly.

9. The method of displaying image files as recited in claim 6, wherein each image file comprises a tag for storing the metadata.

10. The method of displaying image files as recited in claim 6, further comprising providing an image information table for storing the metadata.
